(19) United States
(12) Patent Application Publication
(10) Pub. No.: US 2022/0278390 A1
(43) Pub. Date: Sep. 1, 2022

(54) ELECTRIC BATTERY AND MOTOR VEHICLE

(71) Applicant: Mahle International GmbH, Stuttgart (DE)

(72) Inventors: Peter Geskes, Ostfildern (DE); Georg Votteler, Backnang (DE); Johannes Weinmann, Stuttgart (DE)

(21) Appl. No.: 17/681,773

(22) Filed: Feb. 26, 2022

(30) Foreign Application Priority Data
Feb. 26, 2021 (DE) 10 2021 201 840.8
Apr. 21, 2021 (DE) 10 2021 203 977.4

(51) Int. Cl. H01M 10/6556; H01M 10/6554; H01M 10/613; H01M 10/625; H01M 10/653; H01M 50/242; H01M 50/249; H01M 50/271; H01M 50/184

(52) U.S. Cl. CPC H01M 10/6556; H01M 10/6554; H01M 10/613; H01M 10/625; H01M 10/653; H01M 50/242; H01M 50/249; H01M 50/271; H01M 50/184

(57) ABSTRACT

An electric battery may include a battery housing, at least one battery cell module, a coolant supply and discharge, and a sealing mechanism. The battery housing may partially surround a housing interior and may include at least one housing opening that may be sealed via a cooling plate. The least one battery cell module may be arranged in the housing interior and on the cooling plate. The coolant supply and discharge may be disposed outside of the battery housing. The coolant supply and discharge may, fluidically separated from the housing interior, communicate with a coolant path of the cooling plate. The sealing mechanism may be arranged between the cooling plate and the battery housing such that the sealing mechanism seals both the housing interior as well as a transition from the coolant supply and discharge to the coolant path against external surroundings of the battery housing.

### CROSS-REFERENCE TO RELATED APPLICATIONS

This application claims priority to German Provisional Patent Application No. DE 10 2021 201 840.8, filed on Feb. 26, 2021, and German Patent Application No. DE 10 2021 203 977.4, filed on Apr. 21, 2021, the contents of both of which are hereby incorporated by reference in their entirety.

### TECHNICAL FIELD

The invention relates to an electric battery and to a motor vehicle, in particular to an electric vehicle with a purely electric drive.

### BACKGROUND

For some time, electric batteries for motor vehicles have been realised in modular form with multiple battery cell modules which are arranged in a common battery housing where they are cooled through heat transfer to a coolant.

Solutions are known, with which the coolant is conducted through cooling plates which form a part of the battery housing and are additionally thermally coupled to the battery cell modules. By means of a common coolant supply, the coolant is distributed over the individual cooling plates and, having flowed through the cooling plates and absorbed heat from the battery cell modules accompanied by this, is again discharged via a common coolant discharge.

Often it proves to be problematic that with inadequate sealing of the fluid connection between the cooling plates and the coolant supply or coolant discharge the coolant can leak out into the external surroundings of the battery. A reliable sealing of the housing interior relative to the outer surroundings is therefore particularly important so that in the case of a damaged seal at the transition between coolant supply or coolant discharge and the cooling plates coolant leaked out there cannot enter the housing interior and damage the battery cell modules arranged there despite this.

Conventional sealing concepts, which are to prevent a leakage of coolant out of the coolant supply or coolant discharge and entry into the housing interior accompanied by this are technically involved and thus expensive to produce.

### SUMMARY

It is therefore an object of the present invention to create an improved embodiment for an electric battery which takes into account the problem mentioned above. In particular, an electric battery with an improved sealing concept is to be created which is characterised by a technically simple feasibility and thus also by reduced production costs.

This object is solved through the subject matter of the independent patent claim(s). Preferred embodiments are the subject matter of the dependent patent claim(s).

Accordingly, the basic idea of the invention is to equip an electric battery having multiple battery cell modules which are arranged in a common housing with a sealing device which ensures a sealing of the housing interior against the outer surroundings of the battery and also a sealing of the coolant supply/coolant discharge against the cooling plate that can be flowed through by the coolant. This proposal includes solutions with which for each individual battery cell module a separate cooling plate is provided, which is thus supplied with the coolant via the common coolant supply and from which the coolant, having flowed through the cooling plate, is again discharged via the common coolant discharge. According to the invention, such sealing device is provided for each cooling plate in this case. By means of the sealing device it can thus be ensured on the one hand that no coolant can leak out at the transition between coolant supply/coolant discharge and the respective cooling plate and on the other hand it is ensured independently of this that no coolant whatsoever can enter from the external surroundings into the housing interior.

An electric battery according to the invention includes a battery housing, preferentially of an electrically insulating plastic, which partially surrounds a housing interior and comprises at least one housing opening, preferentially multiple housing openings, wherein the at least one housing opening is sealed by means of a cooling plate. In at least one, preferentially each cooling plate present a coolant path that can be flowed through by a coolant is formed, which extends from a path inlet to a path outlet. Further, the battery cell includes at least one battery cell module arranged in the housing interior, preferentially multiple such battery cell modules for storing electric energy. Here, each battery cell module arranged in the housing interior is thermally coupled to one of the cooling plates. Practically, a cooling plate for cooling the battery cell module and a housing opening, via which the battery cell module can be introduced into the housing interior is thus provided for each battery cell module arranged in the housing interior. Further, the battery cell includes a coolant supply and discharge provided outside on the battery housing, which fluidically separated from the housing interior communicates with the coolant paths. The coolant supply channel serves for distributing the coolant into the coolant paths formed in the cooling plates. The coolant discharge channel serves for collecting the coolant having flowed through the coolant paths. To this end, the coolant supply channel and the coolant discharge channel both communicate fluidically with the coolant paths.

For each cooling plate of the battery cell, the battery cell includes a separate sealing device. According to the invention, each sealing device is arranged between the cooling plate and the battery housing so that it seals both the housing interior and also a transition from the coolant supply and discharge to the coolant path against the external surroundings of the battery housing.

In a preferred embodiment, the coolant supply and discharge for each cooling plate includes a coolant supply channel fluidically communicating with the path inlet and a coolant discharge channel fluidically communicating with the path outlet. In this embodiment, all coolant supply channels communicate fluidically with a common coolant distributor channel of the coolant supply and discharge and all coolant discharge channels communicate fluidically with a common coolant collector channel of the coolant supply and discharge. This embodiment simplifies the distribution of the coolant over the individual cooling plates and the collecting of the coolant having flowed through the cooling plates.

At least the coolant supply channels and at least the coolant discharge channels are at least partially formed by at least one recess formed outside on the battery housing, which is sealed in a fluid-tight manner by means of a cover preferentially formed in the manner of a tubular body that is fastened to the battery housing. This variant can be easily realised technically and requires only little installation space.

Particularly preferably, all sealing devices introduced above are each formed in one piece. Such sealing devices are particularly simple in construction so that cost advantages for producing the battery materialise, in particular when a larger quantity of battery cell modules and thus also a larger quantity of sealing devices are used.

In a preferred embodiment, each sealing device is arranged in the mounted state of the battery with a main portion between the cooling plate and the battery housing and with two sub-portions at the transition at least partially between the cooling plate and the coolant supply and discharge. Thus, an effective sealing of the housing interior relative to the external surroundings of the battery housing can be achieved. The same applies to the sealing of the coolant supply and discharge relative to the external surroundings of the battery. In addition to this, a sealing device formed in such a manner facilitates a simple mounting of the same on the battery housing.

Practically, the sealing devices can be preassembled on the battery housing during the course of the assembly of the battery. To this end it is conceivable to provide on the battery housing a receiving groove in which the sealing device prior to fastening the respective cooling plate on the battery housing is arranged, so that the sealing device is partially received in the same.

According to an advantageous further development, the main portion has a rectangular shape with two narrow and two wide sides. In this further development, the sub-portions each have an angular, preferentially a circular geometry. Each of the two sub-portions can each be connected to a narrow or wide side of the rectangular main portion by means of a preferentially linear intermediate portion. This variant is particularly easy to produce and thus cost-effective.

Particularly practically, the respective sealing device with the main portion surrounds a top side of the cooling plate facing the battery housing along its outer edge. In this variant, the respective sealing device with the first sub-portion surrounds the path inlet of the cooling plate and with a second sub-portion the path outlet of the cooling plate. This variant can be particularly easily mounted on the battery housing.

Practically, the sealing devices can each be formed in the manner of a sealing ring, preferably with a round, particularly preferably with a circular profile. Such sealing rings can also be particularly easily and thus cost-effectively produced.

According to another preferred embodiment, the coolant paths present in the cooling plates are formed by a hollow space with channel-like geometry formed in the respective channel plate. This allows an effective coupling of the coolant to the respective battery cell module so that waste heat generated by the respective battery cell module during the operation of the battery can be effectively transferred to the coolant.

According to a further advantageous further development, a thermal adapter layer is arranged between at least one, preferentially each battery cell module and the cooling plate assigned to this battery cell module. The adapter layer can be formed in particular by a heat-conducting paste or by a heat-conducting pad. In this way, the thermal coupling between the coolant flowing through the cooling plate and the battery cell module and thus the efficiency of the cooling process can be improved.

According to a further advantageous further development, the battery housing is arranged with an underside comprising the housing openings on a frame-like crash structure, preferentially of metal. In this way, the mechanical strength of the entire battery relative to external mechanical influences such as impacts or shocks, in particular when the battery is employed in a motor vehicle, is improved. Undesirable damage to the battery due to impact or shock can thereby be counteracted.

According to another advantageous further development, the coolant supply and discharge can comprise multiple mechanical stiffening elements. In this way, the mechanical strength of the electric battery is also improved further and damage through mechanical shocks, impacts and the like counteracted.

In another preferred embodiment, each battery cell module includes an electrical positive connection and an electrical negative connection. Further, the battery includes an electrical current conduction for supplying the battery cell modules arranged in the housing interior with electric energy or for providing the energy stored in the battery cell modules. The electrical current conduction includes a first electrical conductor rail and a second electrical conductor rail, each of an electrically conductive material, which are both at least partially arranged outside on the battery housing. The first conductor rail includes multiple rail elements by means of which a positive connection and a negative connection each are electrically connected to one another in the housing interior of adjacent battery cell modules. The second electrical conductor rail practically functioning as earth line is electrically connected to the negative connection of one of the battery cell modules. For each battery cell module, a first and a second cut-out are formed in the battery housing through which a rail element of the first conductor rail each electrically connecting the two adjacent battery cell modules is passed. According to the invention, the battery includes a cover of an electrically insulating plastic formed separately from the battery housing that can—detachably or non-detachably—be fastened to the same which covers the conductor rails in the region outside the housing interior.

According to an advantageous further development, the cover is formed U-shaped in profile with a U-base and two U-legs, wherein on the two U-legs a clamping structure for fixing the cover to the battery housing is present. By means of the clamping structure, the cover can be simply yet reliably fixed to the battery housing. In addition, a cover configured in such a manner is easy to produce and is thus accompanied by low manufacturing costs.

According to a further advantageous further development, a separating element of an electrically insulating plastic can be moulded onto the cover, in particular onto the U-base of the same. Practically, the separating element and the cover are formed in one piece and material-uniformly. The said separating element can subdivide the interior delimited by the cover and the battery housing into a first compartment, in which—in the assembled state of the battery—the first conductor rail is received, and into a second compartment, in which the second conductor rail is received. In this way, a spatial electrical separation of the two electrical conductor rails from one another is ensured as a result of which in particular an undesirable electrical short circuit between the two electrical conductor rails, even in the case of vibrations and the like, which in the absence of the separating element, could lead to a brief contact of the two conductor rails, is avoided.

Particularly preferably, the separating element can comprise a first element portion by means of which a film hinge is hinged to a second element portion of the separating element. In this variant, the first element portion is firmly connected to the U-base, in particular integrally moulded on the same, whereas the second element portion can be or is detachably fastened to the U-base. With a separating element configured in such a manner, the second conductor rail can be easily preassembled initially in the second compartment. Following this, the cover with the preassembled second conductor rail can be fastened to the battery housing with the first conductor rail preassembled there. Following the arranging of the second conductor rail on the cover the separating element can be folded over by means of the film hinge and the second element portion fastened to the U-base by means of a clip-on connection or snap-on connection. This makes possible a stable fixing of the separating element to the cover or to the U-base of the same. Preferably, following the fastening by means of the clip-on or snap-on connection, the separating element and the U-base together surround the second compartment.

In another preferred embodiment, a mechanical stiffening structure with multiple preferentially rib-like stiffening elements is formed on the electrical current conduction. In this way, the mechanical stiffness of the electrical current conduction and thus its resistance to external influences, in particular mechanical impacts or mechanical shocks or the like can be increased.

Practically, the electrical current conduction can be arranged on a side of the battery housing located opposite the coolant supply and discharge. This measure simplifies both the mounting of the coolant supply and discharge and also of the electrical current conduction on the battery housing.

Particularly practically, the cover is an extruded part. A cover configured in such a manner can be manufactured particularly cost-effectively.

Further, the invention relates to a motor vehicle, in particular an electric vehicle with purely electric drive. The motor vehicle includes a body and an electric battery according to the invention introduced above. The advantages of the battery according to the invention explained above therefore apply also to the motor vehicle according to the invention. Preferably, the battery includes the crash structure explained above. In this case, the battery is preferably connected to the body of the motor vehicle via the crash structure.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description wherein same reference numbers relate to same or similar or functionally same components.

### BRIEF DESCRIPTION OF THE DRAWINGS

It shows, in each case schematically:

FIGS. 1a and 1b show an example of an electric battery in a perspective representation,

FIG. 2 in different representations,

FIG. 2 shows a first sectional view of the battery of FIG. 1,

FIG. 3 shows a sectional view of the battery of FIG. 1 that is distinct from the first sectional view,

FIG. 4 shows a plan view of one of the cooling plates,

FIG. 5 shows an individual battery cell module in a plan view,

FIG. 6 shows a battery in a further sectional view, in which the electrical current conduction is shown,

FIG. 7 shows the cover of the electrical current conduction shown in FIG. 6 in a separate and enlarged representation.

### DETAILED DESCRIPTION

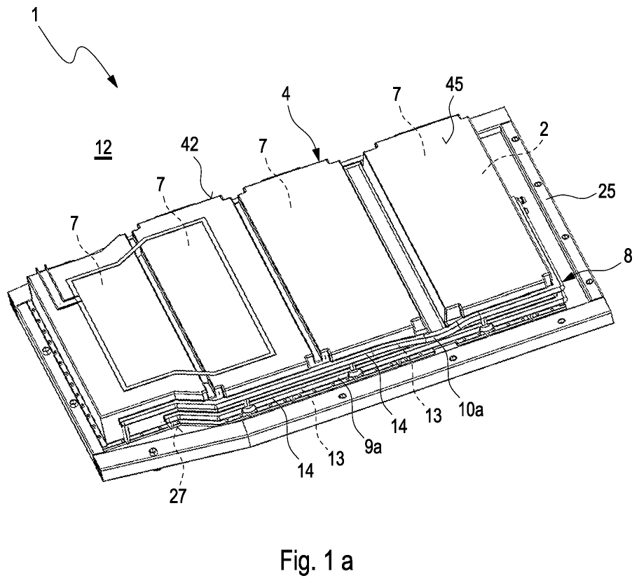

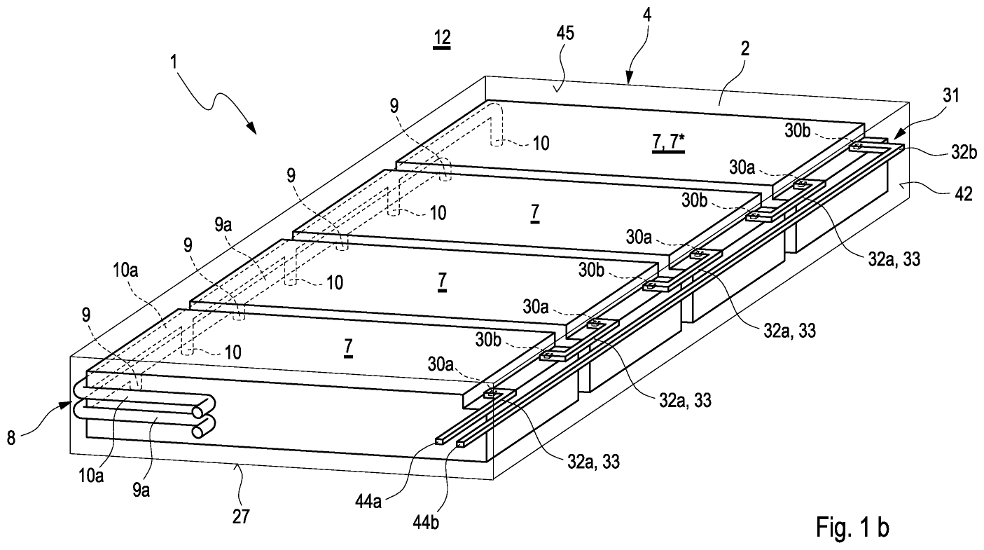

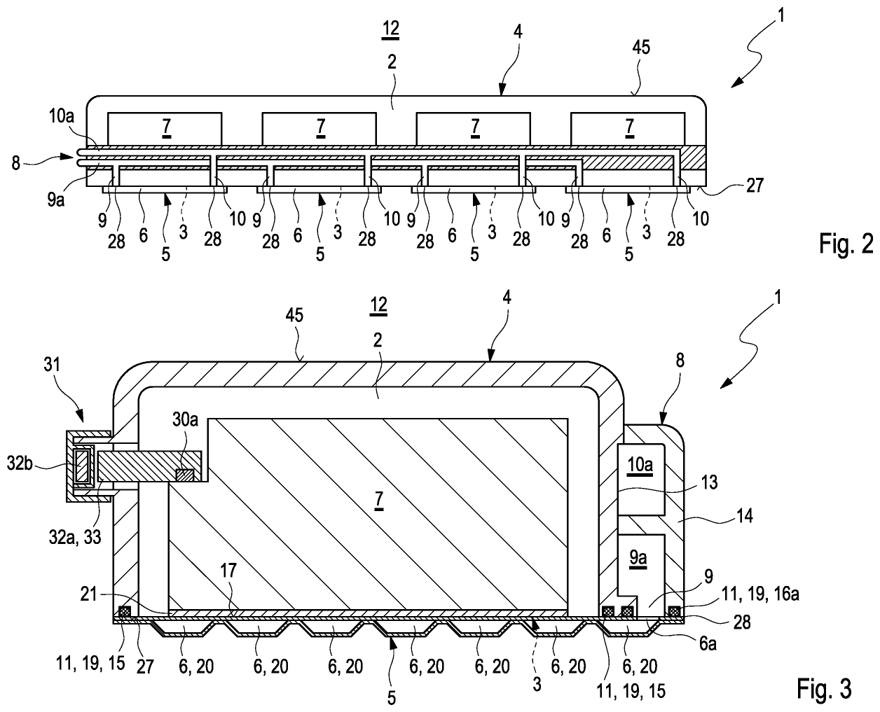

The FIGS. 1a and 1b illustrate an example of an electric battery 1 in two different perspective representations, FIG. 2 in a sectional representation. The battery 1 includes a battery housing 4 of an electrically insulating plastic, which partially surrounds a housing interior 2 and on its underside 27 comprises multiple housing openings 3 spaced apart from one another. Each of the housing openings 3 is sealed by means of a plate designed as cooling plate 5, in which a coolant path 6 that can be flowed through by a coolant is formed. The battery 1, further, includes multiple battery cell modules 7 arranged in the housing interior 2 for storing electric energy, wherein each battery cell module 7 is arranged on one of the cooling plates 5 and thermally connected to this cooling plate 5. Each battery cell module 7 can be introduced into the housing interior 2 via a defined one of the housing openings 3.

According to FIG. 1a, the battery housing 4 can be arranged with an underside 27 comprising the housing openings 3 on a frame-like crash structure 25 (not shown in FIG. 1b), preferentially of metal. The mechanical connection of the battery cell 1 to a motor vehicle can take place by means of the crash structure 25.

As is noticeable from the FIGS. 1a, 1b and 2, a coolant supply and discharge 8 is provided outside on the battery housing 4 which fluidically communicates with the coolant paths 6 of the cooling plates 5, so that via the coolant supply and discharge 8 the coolant can be introduced into the coolant paths 6 and, having flowed through the coolant path 6, be again discharged from the cooling plates 5.

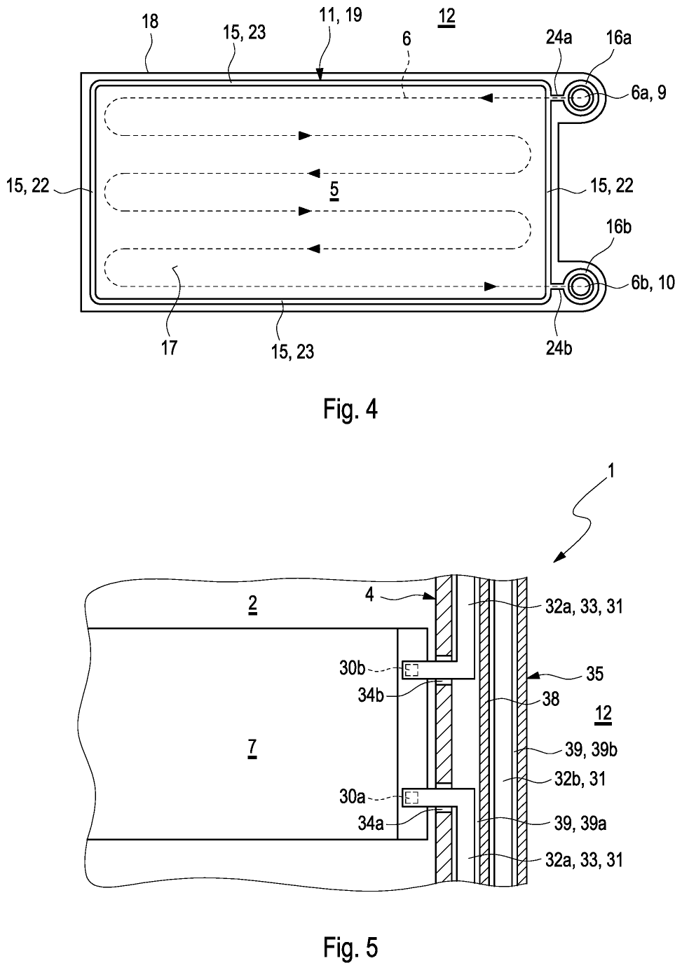

FIG. 3 shows a further sectional representation of the battery cell 1 in a section running perpendicularly to that of FIG. 2. FIG. 4 shows a plan view of a top side 17 of an individual cooling plate 5 facing the battery housing 4.

As is clearly noticeable in FIG. 3, a thermal adapter layer 21 can be arranged between each battery cell module 7 and the cooling plate 5 assigned to this battery cell module 7 in order to improve the thermal coupling of the battery cell module 7 to the cooling plate 5 in this way. The adapter layer 21 can be formed for example by a heat-conducting paste or a heat-conducting pad of a material with a high heat conductivity.

As is noticeable in the FIGS. 3 and 4, the coolant paths 6 present in the cooling plates 5 can be formed by a hollow space 20 with a channel-like geometry formed in the respective channel plate 5 and extend from a path inlet 6a to a path outlet 6b. The coolant supply and discharge 8 includes for each cooling plate 5 a coolant supply channel 9 communicating with the respective path inlet 6a and a coolant discharge channel 10 fluidically communicating with the path outlet 6b. All coolant supply channels 9 communicate fluidically with a common coolant distributor channel 9a of the coolant supply and discharge 8. All coolant discharge channels 10 communicate fluidically with a common coolant collector channel 10a of the coolant supply and discharge 8.

The coolant distributor channel 9a serves for supplying the coolant into the coolant paths 6 formed in the cooling plates 5. The coolant collector channel 10a serves for collecting the coolant having flowed through the coolant paths 6. The coolant supply channels 9 and the coolant discharge channels 10 as well as the common coolant distributor channel 9a and the common coolant collector channel 10a can each be at least partially formed by at least one recess 13 formed outside on the battery housing 4, which is sealed in a fluid-tight manner by means of a cover 14 preferentially formed in the manner of a tubular body fastened to the battery housing 4.

Further, it is noticeable in the FIGS. 3 and 4 that for each cooling plate 5 present a sealing device 11 is provided. The sealing device 11 is arranged between the cooling plate 5 and the battery housing 4 so that it seals both the housing interior 2 as well as the coolant supply channel 9 and the coolant discharge channel 10, in the region of the transition 28 to the coolant path 6 in each case against the external surroundings 12 of the battery housing 4.

As is noticeable in particular from the representation of FIG. 4, the sealing device 11 is preferably formed in one piece. The sealing device 11 can be formed by a sealing ring 19, preferentially with a round, particularly preferably with a circular profile.

According to the FIGS. 3 and 4, the sealing device 11 can be arranged with a main portion 15 between the cooling plate 5 and the battery housing 4 and be arranged with two sub-portions 16a, 16b at the transition 28 between the cooling plate 5 and the coolant supply and discharge 8. In this way, the simultaneous sealing both of the housing interior 2 and also of the respective coolant supply channel 9 and coolant discharge channel 10 against the external surroundings 12 that is substantial for the invention is achieved on each cooling plate 5 by means of a single sealing device 11.

As is illustrated by the plan view of FIG. 4 of the top side 17 of the cooling plate 5, the sealing device 11 surrounds with its main portion 15 the top side 17 of the cooling plate 5 facing the battery housing 4 along its outer edge 18. In the example of FIG. 4, the main portion 15 in the shown plan view has a rectangular shape with rounded corners and with two narrow and two wide sides 22, 23, whereas the two sub-portions 16a, 16b each have a round, preferentially circular geometry.

According to FIG. 4, the two sub-portions 16a, 16b in the shown plan view are arranged spaced apart from one another and both are each connected to one of the two narrow sides 22 of the rectangular main portion 15 by means of a linear intermediate portion 24a, 24b. Here, the first sub-portion 16a surrounds the path inlet 6a of the cooling plate 5 and the second sub-portion 16b the path outlet 6b of the cooling plate 5.

As is noticeable from FIG. 1b, each battery cell module 7 additionally includes an electrical positive connection 30a and an electrical negative connection 30b. Further, the battery 1 comprises an electrical current conduction 31 for supplying the battery cell module 7 arranged in the housing interior 2 with electric energy. The electrical current conduction 31 again includes a first electrical conductor rail 32a and a second electrical conductor rail 32b, each of an electrically conductive material.

As is illustrated by FIG. 1b and FIG. 2, the first conductor rail 32a is partially and the second conductor rail 32b completely arranged outside on the battery housing 4. The electrical current conduction 31 with the two conductor rails 32a, 32b can be practically arranged on a side 42 of the battery housing 4 located opposite the coolant supply and discharge 8. On the electrical current conduction 31, a mechanical stiffening structure with multiple preferentially rib-like stiffening elements (not shown) can optionally be formed.

The first conductor rail 32a includes multiple separate rail elements 33, by means of which a positive connection 30a and a negative connection 30b each of two adjacent battery cell modules 7 in the housing interior 2 are electrically connected to one another. In this way, the individual battery cell modules 7 can be electrically connected in series to one another. For realising such an electrical series connection, the second electrical conductor rail 32b is electrically connected to the negative connection 30b of one of the battery cell modules 7, which for illustration is additionally marked with the reference number 7* in FIG. 1b. The second electrical conductor rail 32 thus assumes the function of an electrical earth line. The two electrical conductor rails 32a, 32b can be connected to a respective connection portion 44a and 44b respectively with an electrical consumer (not shown) and/or with an electric energy source (not shown).

FIG. 5 shows an individual battery cell 7 in a plan view of the battery housing, wherein a top side 45 of the battery housing 4 is not shown so that the housing interior 4 with the battery cell module 7 is noticeable.

The FIGS. 1b and 5 illustrate that for each battery cell module 7 in the battery housing 4 a first and a second cut-out 34a, 34b are formed, through which a rail element 33 of the first conductor rail 32a electrically connecting the two adjacent battery cell modules 7 each is passed. Such a rail element 33 with preferentially U-shaped geometry connects, as already explained, the electrical positive connection 30a of a defined battery cell module 7 with the electrical negative connection 30b of the adjacent battery cell module 7, so that the already mentioned electrical series connection of the battery cell modules 7 is realised. Each rail element 33 is partially arranged in the housing interior 2 and partially outside the battery housing 4.

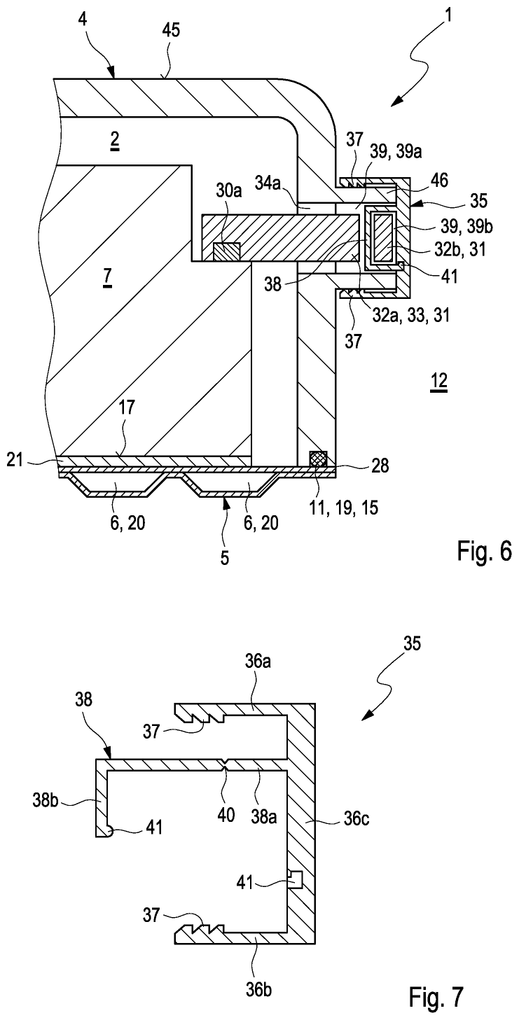

FIG. 6 shows the battery 1 in a further sectional view. The FIGS. 5 and 6 illustrate that the battery 1 includes a longitudinal cover 35 preferably formed as profile part that can be fastened to the battery housing 4 of an electrically insulating plastic which in a state fastened to the battery housing 4 covers the two conductor rails 32a, 32b—and thus also all first and second cut-outs 34a and 34b respectively. In this way it is prevented that the electrical conductor rails 32a, 32b carrying an electric current during the operation of the battery 1 are exposed outside the battery housing 4. The cover 35 is preferably an extruded part of plastic.

FIG. 7 shows the cover 35 in profile and in a separate enlarged representation. According to the FIGS. 6 and 7, the cover 35 is formed U-shaped in profile and comprises a U-base 36c and a first and second U-leg 36a, 36b, which on the end side project at an angle, preferably at a right angle from the U-base 36c.

From the FIGS. 6 and 7 it is evident that on the two U-legs 36a, 36b a clamping structure 37 each for fixing the cover 35 to the battery housing 4 can be formed. On the cover 35, in particular on the U-base 36c, a separating element 38 of an electrically insulating plastic can be additionally moulded, which subdivides an interior 39 delimited by the cover 35 and the battery housing 5 into a first compartment 39a, in which the first conductor rail 32a can be received, and into a second compartment 39b, in which the second conductor rail 30b can be received.

According to the FIGS. 6 and 7, the separating element 38 can include a first element portion 38a which, by means of a film hinge 40, is hinged to a second element portion 38b of the separating element 38. Here, the first element portion 38a is firmly connected to the U-base 36 and in particular integrally moulded on the same. Practically, the second element portion 38b is detachably fastened to the second element portion 38b by means of a clip-on connection or snap-on connection 41. According to FIG. 6, the separating element 38 and the U-base 36c together surround, in the mounted state of the conductor rails 32a, 32b and of the cover 35 on the battery housing 4, the second compartment 39b.

The assembly of the electric battery 1 can take place as follows:

Initially, the first conductor rail 32a with the rail elements 33 can be preassembled on the battery housing 4, so that the rail elements 33 following such a preassembly engage through the first and second cut-outs 34a, 34b towards the inside, into the housing interior 2. Following this, the individual battery cell modules 7 can be introduced via the respective housing opening 3 into the housing interior 2 and fixed to the battery housing 4 there. The fastening of the battery cell modules 7 to the battery housing 4 can take place for example with the help of suitable screw connections (not shown). During the course of the arrangement of the battery cell modules 7 in the housing interior 2, the respective electrical positive connections 30a and electrical negative connections 30b of the battery cell modules 7 are then electrically and mechanically connected to the preassembled rail elements 33—for example by means of plug connections (not shown).

Following this, the already mentioned thermal adapter layer 21—for example as heat-conducting paste, can be optionally applied to the undersides of the battery cell modules 7 facing the housing openings 3.

In a next mounting step, the second conductor rail 32b is mounted to the cover 35. To this end, the second conductor rail 32b is initially preassembled on the cover 35 and for this purpose arranged in the region of the separating element 38. Following this, the second element portion 38b is folded round about the second conductor rail 32b by means of the film hinge 40. By subsequently fixing the second element portion 38b of the separating element 38 to the U-base 36c of the cover 35 by means of the clip-on connection 41, the second conductor rail 32b is permanently fixed in the second compartment 39b of the interior 39 formed in this manner.

The unit of second conductor rail 32b and cover 35 formed in this way is subsequently fastened with the help of the clamping structures 37 to a housing collar 46 (see FIG. 3) projecting from the battery housing 4 or directly to the battery housing 4—if no housing collar 46 is provided. During the course of this fastening, the second conductor rail 32b can also be electrically and mechanically connected to the electrical negative connection 30b of the battery cell module 7*—just as the rail elements 33 of the conductor rail 32a—for example by means of a plug connection.

Following this, both the first conductor rail 32a and also the second conductor rail 32b are covered by means of the cover 35 and fixed on the battery housing 4 as desired.

1. An electric battery, comprising:
a battery housing partially surrounding a housing interior and including at least one housing opening that is sealed via a cooling plate;
the cooling plate including a coolant path through which a coolant is flowable, the coolant path extending from a path inlet to a path outlet;
at least one battery cell module arranged in the housing interior for storing electric energy, the at least one battery cell module arranged on the cooling plate;
a coolant supply and discharge disposed outside of the battery housing and through which the coolant is flowable, the coolant supply and discharge, fluidically separated from the housing interior, communicating with the coolant paths; and
a sealing mechanism arranged between the cooling plate and the battery housing such that the sealing mechanism seals both the housing interior as well as a transition from the coolant supply and discharge to the coolant path against external surroundings of the battery housing.

2. The electric battery according to claim 1, wherein the coolant supply and discharge includes:
a coolant supply channel fluidically communicating with the path inlet;
a coolant discharge channel fluidically communicating with the path outlet;
a common coolant distributor channel in fluid communication with the coolant supply channel; and
a common coolant collector channel in fluid communication with the coolant discharge channel.

3. The electric battery according to claim 1, wherein the coolant supply channel and the coolant discharge channels are at least partially formed by at least one recess formed on an outside of the battery housing that is sealed in a fluid-tight manner via a cover.

4. The electric battery according to claim 1, wherein the sealing mechanism formed in one piece.

5. The electric battery according to claim 1, wherein the sealing mechanism includes:
a main portion arranged between the cooling plate and the battery housing; and
two sub-portions arranged at least partially at the transition between the cooling plate and the coolant supply and discharge.

6. The electric battery according to claim 5, wherein:
the main portion has a rectangular shape with two narrow sides and two wide sides;
the two sub-portions each have an angular geometry; and
each of the two sub-portions is connected via a respective linear intermediate portion to at least one of (i) a narrow side of the two narrow sides and (ii) a wide side of the two wide sides of the main portion.

7. The electric battery according to claim 6, wherein:
the main portion of the sealing mechanism, in a plan view of the cooling plate, surrounds a top side of the cooling plate facing the battery housing along an outer edge of the cooling plate;
a first sub-portion of the two sub-portions of the sealing mechanism, in the plan view, surrounds the path inlet of the cooling plate; and
a second sub-portion of the two sub-portions of the sealing mechanism, in the plan view, surrounds the path outlet of the cooling plate.

8. The electric battery according to claim 1, wherein the sealing mechanism is configured as a sealing ring.

9. The electric battery according to claim 1, further comprising a thermal adapter layer arranged between the at least one battery cell module and the cooling plate.

10. The electric battery according to claim 1, wherein the coolant supply and discharge includes a plurality of mechanical stiffening elements.

11. The electric battery according to claim 1, wherein the at least one housing opening is disposed on an underside the battery housing, which is arranged on a frame-like crash structure.

12. A motor vehicle comprising:
a body;
a frame-like crash structure;
an electric battery connected to the body via the crash structure;
wherein the electric battery includes:
a battery housing partially surrounding a housing interior, the battery housing including at least one housing opening;
at least one cooling plate sealing the at least one housing opening, the at least one cooling plate including a coolant path through which a coolant is flowable, the coolant path extending from a path inlet to a path outlet;
at least one battery cell module arranged in the housing interior for storing electric energy, the at least one battery cell module arranged on the at least one cooling plate;
a coolant supply and discharge disposed outside of the battery housing and through which the coolant is flowable, the coolant supply and discharge, fluidically separated from the housing interior, communicating with the coolant path; and
a sealing mechanism arranged between the at least one cooling plate and the battery housing such that the sealing mechanism seals both the housing interior as well as a transition from the coolant supply and discharge to the coolant path against external surroundings of the battery housing.

13. An electric battery, comprising:
a battery housing partially surrounding a housing interior;
a plurality of battery cell modules arranged in the housing interior;
the battery housing including a plurality of housing openings via which the plurality of battery cell modules are introducible into the housing interior;
a plurality of cooling plates each sealing a respective housing opening of the plurality of housing openings;
the plurality of cooling plates each including a coolant path of a plurality of cooling paths through which a coolant is flowable, the plurality of coolant paths each extending from a respective path inlet to a respective path outlet;
the plurality of battery cell modules each arranged on a respective cooling plate of the plurality of cooling plates;
a coolant supply and a coolant discharge disposed outside of the battery housing and through which the coolant is flowable, the coolant supply and the coolant discharge communicating with the plurality of coolant paths fluidically separated from the housing interior; and
a plurality of sealing mechanisms each arranged between a respective cooling plate of the plurality of cooling plates and the battery housing such that the sealing mechanism seals both the housing interior as well as a transition from the coolant supply and the coolant discharge to the coolant path of the respective cooling plate against external surroundings of the battery housing.

14. The electric battery according to claim 13, wherein:
the coolant supply includes (i) a plurality of coolant supply channels that are each connected to the path inlet of a respective cooling plate and (ii) a common coolant distributor channel to which the plurality of coolant supply channels are each connected; and
the coolant discharge includes (i) a plurality of coolant discharge channels that are each connected to the path outlet of a respective cooling plate and (ii) a common coolant collector channel to which the plurality of coolant discharge channels are each connected.

15. The electric battery according to claim 14, further comprising a cover, wherein:
the battery housing includes at least one recess disposed in an external surface of the battery housing; and
the cover is connected to the battery housing and closes the at least one recess in a fluid-tight manner such that the plurality of coolant supply channels and the plurality of coolant discharge channels are at least partially defined therebetween.

16. The electric battery according to claim 13, wherein each of the plurality of sealing mechanisms include:
a main portion arranged between the respective cooling plate and the battery housing;
a first sub-portion arranged at least partially at the transition between the respective cooling plate and the coolant supply; and
a second sub-portion arranged at least partially at the transition between the respective cooling plate and the coolant discharge.

17. The electric battery according to claim 16, wherein:
each of the plurality of sealing mechanisms further include a plurality of linear intermediate portions;
the main portion has a rectangular shape with two narrow sides and two wide sides;
the first sub-portion and the second sub-portion each have a circular geometry; and
the first sub-portion and the second sub-portion are each connected to at least one of (i) a narrow side of the two narrow sides and (ii) a wide side of the two wide sides via a respective intermediate portion of the plurality of linear intermediate portions.

18. The electric battery according to claim 17, wherein:
the main portion extends along an outer edge of the respective cooling plate on a top side of the respective cooling plate facing the battery housing;
the first sub-portion surrounds the path inlet of the respective cooling plate; and
the second sub-portion surrounds the path outlet of the respective cooling plate.

19. The electric battery according to claim 13, further comprising a plurality of thermal adapter layers each arranged between a respective battery cell module of the plurality of battery cell modules and the respective cooling plate on which the respective battery cell module is arranged.

20. The electric battery according to claim 13, wherein at least one of the coolant supply and the coolant discharge includes a plurality of mechanical stiffening elements.
